(19) United States
(12) Patent Application Publication
(10) Pub. No.: US 2025/0200322 A1
(43) Pub. Date: Jun. 19, 2025

(54) INFORMATION PROCESSING DEVICE, INFORMATION PROCESSING METHOD, AND NON-TRANSITORY COMPUTER READABLE MEDIUM

(71) Applicant: Preferred Networks, Inc., Tokyo-to (JP)

(72) Inventor: So TAKAMOTO, Tokyo-to (JP)

(73) Assignee: Preferred Networks, Inc., Tokyo-to (JP)

(21) Appl. No.: 18/980,014

(22) Filed: Dec. 13, 2024

(30) Foreign Application Priority Data
Dec. 15, 2023 (JP) 2023-212273

(51) Int. Cl. G06N 3/02

(52) U.S. Cl. CPC G06N 3/02

(57) ABSTRACT

An information processing device includes one or more memories; and one or more processors. The one or more processors are configured to acquire, based on information related to positions of a first atom, a second atom, and one or more other atoms, which are included in a plurality of atoms being analysis targets, interaction information on the first atom and the second atom; generate input information into a model to be used for analysis of the plurality of atoms based on the interaction information; and acquire an analysis result of the plurality of atoms by inputting the input information into the model. The interaction information includes information related to presence or absence of interaction.

### CROSS REFERENCE TO THE RELATED APPLICATIONS

This application is based upon and claims the benefit of priority from the Japanese Patent Application No. 2023-212273, filed on Dec. 15, 2023, the entire contents of which are incorporated herein by reference.

### FIELD

This disclosure relates to an information processing device, information processing method, and a non-transitory computer readable medium.

### BACKGROUND

To acquire various kinds of information on a material, an interatomic potential being a function for acquiring energy of a given atomic structure is used. By executing a molecular dynamics simulation using the interatomic potential, physical property values such as energy can be acquired. Neural Network Potential (NNP) is an interatomic potential formed by a neural network, and can use a graph neural network, for example, while regarding it as a graph in which an atom is associated with a node and a set of atoms is associated with an edge.

When using the interatomic potential including NNP, the influence between atoms spaced apart to some extent can be estimated to be small enough, and the interaction between atoms is not arithmetically operated on an all-atom-to-all-atom basis but generally arithmetically operated in less than a certain limited distance (cut-off distance). The decision of the cut-off distance is arbitrary, and if the distance is short, the arithmetic operation can be realized at a high speed but the accuracy decreases, whereas if the distance is long, the accuracy possibly increases but the arithmetic operation time increases.

In the arithmetic operation of the interatomic potential, in the case of a sparse structure, there may be interaction at a long distance, and therefore it is desired to increase the cut-off distance, whereas in the case of a dense structure, combinations of atoms to be arithmetically operated may greatly increase even at a short distance, which possibly becomes an abnormal input as a graph, so that the cut-off distance is desired to be made appropriately short. If the cut-off distance is simply increased in all cases, the arithmetic operation time increases, so that it is more desirable to increase or decrease the cut-off distance according to the presence status of surrounding atoms.

### BRIEF DESCRIPTION OF DRAWINGS

FIG. 1 shows a block diagram schematically illustrating an information processing device according to an embodiment.

FIGS. 2 and 3 show flowcharts illustrating processing of the information processing device according to an embodiment.

FIG. 4 shows a block diagram illustrating an implementation example of the information processing device according to an embodiment.

### DETAILED DESCRIPTION

According to one embodiment, an information processing device includes one or more memories; and one or more processors. The one or more processors are configured to acquire, based on information related to positions of a first atom, a second atom, and one or more other atoms, the first atom, the second atom, and the one or more other atoms being included in a plurality of atoms being analysis targets, interaction information on the first atom and the second atom; generate, based on the interaction information, input information which is inputted into a model to be used for analysis of the plurality of atoms; and acquire an analysis result of the plurality of atoms by inputting the input information into the model. The interaction information includes information related to presence or absence of interaction.

A problem to be solved by embodiments of this disclosure is not limited to the above-described problem and can also be a problem corresponding to effects described in the embodiments as some non-limiting examples of the problem. In other words, the problem corresponding to at least arbitrary one of the effects described in the explanation of the embodiments of this disclosure can be the problem to be solved in this disclosure.

Hereinafter, embodiments of the present invention will be explained with reference to the drawings. The drawings and the description of the embodiments are indicated as examples and are not intended to limit the present invention.

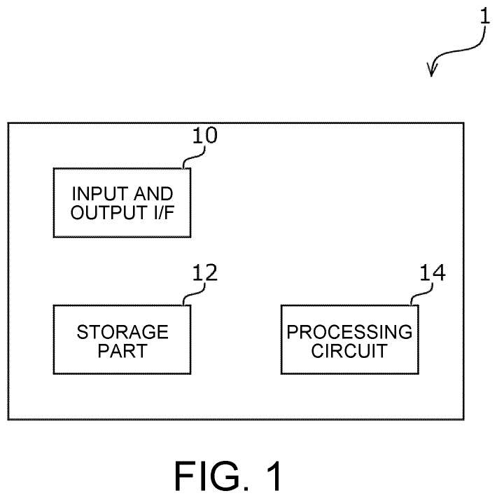

FIG. 1 is a block diagram schematically illustrating an information processing device according to an embodiment. An information processing device 1 includes an input and output I/F 10, a storage part 12, and a processing circuit 14. The information processing device 1 executes calculation of interatomic potential. The information processing device 1 additionally includes a power supply part, a control part, and so on which are required to operate the information processing device 1.

The input and output I/F 10 is an interface which executes input and output of data and so on between the outside and the inside of the information processing device 1. The information processing device 1 acquires, via the input and output I/F 10, information related to an atomic structure of a crystal, an amorphous compound, or a molecule whose physical property value, for example, energy is desired to be calculated. The acquired information may be stored in the storage part 12.

The storage part 12 stores data and so on required for arithmetic processing of the information processing device 1. The storage part 12 does not need to be included inside the information processing device 1, in which case the information processing device 1 does not include the storage part 12 and can acquire data via the input and output I/F 10 from an externally existing memory, storage, or the like.

The processing circuit 14 executes arithmetic processing by software based on, for example, a program and the like stored in the storage part. The processing circuit 14 executes calculation of the interatomic potential based on the atomic structure acquired by the input and output I/F 10.

The calculation of the interatomic potential is executed by the processing circuit 14 based on the atomic structure acquired via the input and output I/F 10. The calculation of the interatomic potential may be executed by a simulation of the first-principles calculation or the like, or may be executed by NNP. In the case where the calculation is executed by NNP, the method to be explained in this disclosure can be used both in training and in inferring a neural network model which forms NNP.

In the calculation of the interatomic potential, the information processing device 1 determines, based on a distance between an atom of interest and another atom, whether to take the other atom into account or not in the calculation of the atom of interest. The distance used for the determination of whether to take the other atom into account or not in the calculation for the atom of interest is a cut-off distance.

The processing circuit 14 acquires the information related to the atomic structure, dynamically decides, based on the atomic structure, the cut-off distance for deciding an atom to be used for an arithmetic operation in the arithmetic operation of the interatomic potential, and executes an arithmetic operation of the interatomic potential according to the cut-off distance.

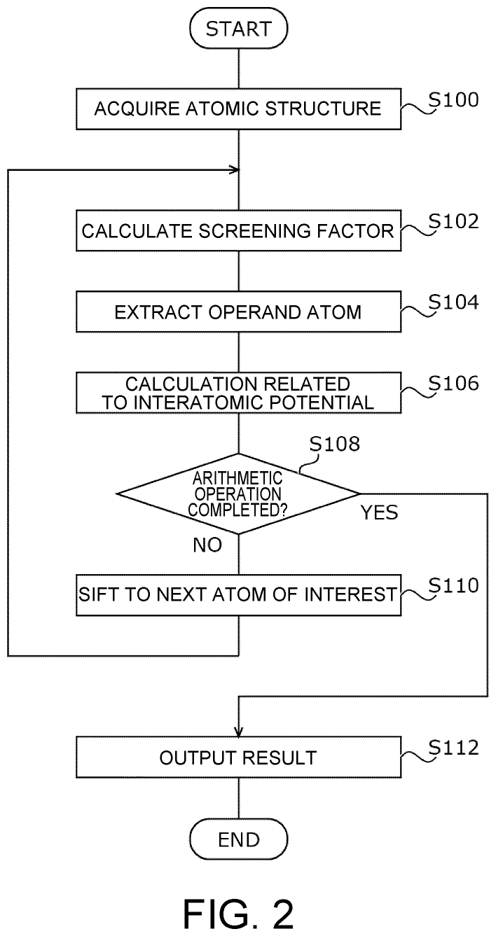

FIG. 2 is a flowchart illustrating processing of the information processing device 1 according to an embodiment. A case of using NNP will be explained below, but the setting of the cut-off distance in this disclosure is not limited to this and can be used for the calculation of other interatomic potentials.

The processing circuit 14 acquires an atomic structure to be used for training or an atomic structure to be used for inference, via the input and output I/F 10 (S100). The processing circuit 14 executes the calculation of the interatomic potential using the information related to the atomic structure.

The processing circuit 14 calculates, for a certain atom (atom of interest) in the structure on which the arithmetic operation of the interatomic potential is to be executed, a screening factor for the atom of interest and a candidate atom being a candidate of an atom whose interaction is to be taken into account when executing the arithmetic operation of the potential for this atom of interest (S102). The processing circuit 14 calculates, for example, the screening factor based on the following screening function.

Note that the screening factor may be defined in this disclosure as information to be used for setting interaction information between atoms (presence or absence of interaction, strength of interaction, and so on), and/or information to be used for determining whether the distance between atoms is the cut-off distance or less. Further, the interaction information can include the screening factor, and the screening factor can be used, for example, as information related to the strength of the interaction.

$${s}_{ij} = \frac{exp ( {ξ}_{ij} ) - exp ( - {ξ}_{ij} )}{exp ( {ξ}_{ij} ) + exp ( - {ξ}_{ij} )} \qquad ( 1 )$$

$${ξ}_{ij} = {β}_{1} {\sum }_{l} exp [ - {{β}_{2} ( \frac{{r}_{il} + {r}_{jl}}{{r}_{ij}} )}^{{β}_{3}} ] \qquad ( 2 )$$

Assuming the atom of interest to be i and the candidate atom whose interaction with the atom i of interest may be required to be taken into account when executing the calculation of potential to be j, the screening factor based on a region where one or more other atoms I are present is calculated for the atoms i and j. rᵢⱼ denotes a distance between the atom i and the atom j, rᵢₗ denotes a distance between the atom i and the atom l, and rⱼᵢ denotes a distance between the atom j and the atom l. β₁, β₂, and β₃ are predetermined positive coefficients. These β₁, β₂, and β₃ may be coefficients changing depending on the kind of the atom. The above equations are shown in M. S. Tang, at.el., “Environment-dependent tight-binding potential model”, Physical Review B, 54, 10982 (1996).

Note that the screening function only needs to be processing capable of appropriately extracting an atom being a target of the arithmetic operation for the atom of interest, and is not limited to the above eq. (1) and eq. (2). The extraction of the atom to be the target of this arithmetic operation can be decided, for example, based on the distance from the atom of interest. As another non-limiting example, the processing circuit 14 can calculate a distance to an atom (candidate atom) around the atom of interest from the input atomic structure, and perform the determination of the cut-off distance and the calculation of the screening factor not taking the interaction into account, based on this distance.

The screening function may be the one in which the kind of the coefficient and/or the function is changed, for example, for each kind of atom. Further, a synthesis of screening functions calculated by a plurality of different calculation expressions can also be used as a final screening function.

The processing circuit 14 calculates a screening factor sᵢⱼ between the atoms i and j based on eq. (1) and eq. (2) as a non-limiting example. The processing circuit 14 determines whether to take the atom j as a target whose interaction in the potential calculation with respect to the atom i of interest is to be taken into account, for example, by comparing the calculated screening factor sᵢⱼ with a predetermined value. As an example, the processing circuit 14 decides, when the screening factor sᵢⱼ exceeds the predetermined value, not to execute the arithmetic operation of the atom i of interest with the atom j in the calculation of the interatomic potential.

The screening factor sᵢⱼ increases in value when the other atom l is present between the atom i and the atom j. Therefore, by using the screening factor, the processing circuit 14 can set the cut-off distance based on the density of atoms surrounding the atom of interest. In other words, the processing circuit 14 executes processing of increasing the cut-off distance as the atoms surrounding the atom of interest are sparse, and decreasing the cut-off distance as the atoms surrounding the atom of interest are dense.

Note that eq. (1) and/or eq. (2) is exemplified as a non-limiting example as explained above, and the calculation of the screening factor and/or the determination of the cut-off distance does not exclude methods other than that. Besides, costs may increase by calculating the screening factors of all of the atoms j and l for the atom i of interest. Therefore, the processing circuit 14 can also determine the cut-off distance between atoms within a predetermined range, for example, while limiting the distance between the atoms i and j. Specifically, the calculation of the screening factor can be omitted assuming no interaction between atoms outside the predetermined range. Further, the other atom l to be taken into account when calculating the screening factor sᵢⱼ may be narrowed down based on a predetermined criterion (a distance between the atom i and the atom j, a distance between the atom i and the atom l, or the like).

The processing circuit 14 extracts the atom being a target of calculation based on the screening factor and then executes the calculation related to the interatomic potential (S106). The processing circuit 14 can also define a matrix based on the screening factor, for example, as an adjacency matrix. In the case of training the model related to NNP or performing inference by NNP, the processing circuit 14 can also execute the creation of the adjacency matrix at this stage.

The processing circuit 14 determines whether the arithmetic operation has been completed (S108). The processing circuit 14 may perform this determination based on whether or not all of the atoms have been designated as the atom of interest and the calculation of the interatomic potential has been executed, for example, in the atomic structure for which the interatomic potential is calculated As another example, a region where the atom of interest is present can be arbitrarily limited, such as not all of the atoms but all of atoms within the predetermined region.

If it is determined that the arithmetic operation has not been completed (S108: NO), the processing circuit 14 extracts the next atom of interest for which the calculation has not been executed yet, and repeats the processing from S102 for this atom of interest.

If it is determined that the arithmetic operation has been completed (S108: YES), the processing circuit 14 outputs a result (S112), and completes the processing. The output of the result may be, for example, storage of the result in the storage part 12 or may be output of the result to the outside of the information processing device 1 via the input and output I/F 10.

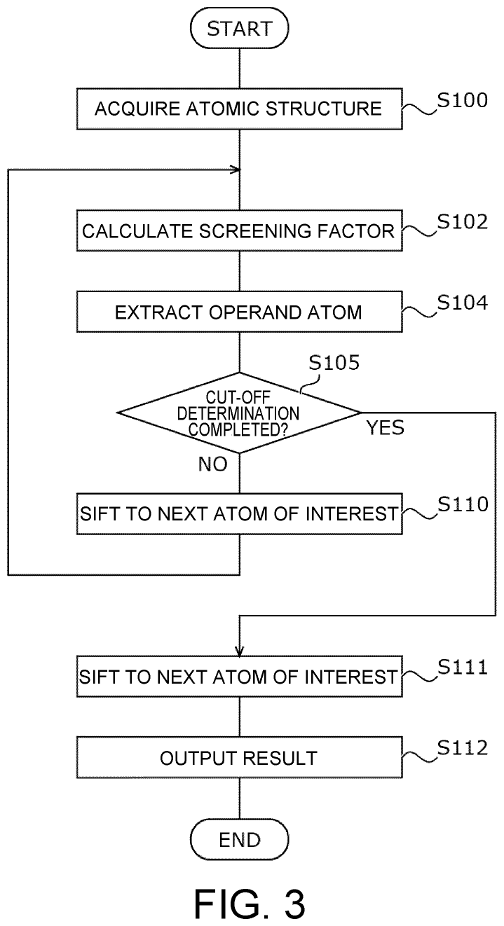

FIG. 3 is a flowchart with a changed order of the arithmetic operation according to an embodiment. The processing circuit 14 first calculates the screening factor for the atom i of interest with respect to the candidate atom j, and determines whether the candidate atom j is within the cut-off distance (S102).

The processing circuit 14 calculates the screening factor for the candidate atom j whose interaction with the atom i of interest is taken into account, and then extracts an operand atom related to the atom i of interest (atom whose interaction with the atom i of interest is taken into account in the calculation of the interatomic potential) (S104).

After this processing, the processing circuit 14 determines whether the scanning of the atom i of interest has been completed, namely, whether the operand atom has been extracted while regarding all of atoms on which the arithmetic operation related to the interatomic potential is executed in the acquired atomic structure, as the atom i of interest (S105).

If the scanning of the atom of interest has not been completed, the processing is shifted to the next atom of interest (S110), and repeated until the extraction processing of the operand atom (S102, S104).

After the completion of the scanning of the atom of interest, the processing circuit 14 executes the arithmetic operation related to the interatomic potential by performing the arithmetic operation of the interaction based on the extracted operand atom for each of atoms in the atomic structure, for example, inputting information on the operand atom for each of atoms into a model related to NNP together with the atomic structure (S111).

The processing circuit 14 outputs a result (S112) and completes the processing. In this manner, the processing circuit 14 can execute the determination based on the cut-off distance on the atoms in the atomic structure, and then execute the arithmetic operation of the interatomic potential by NNP or the like based on the result.

As explained above, according to this embodiment, it is possible to improve the accuracy by increasing the cut-off distance for a sparse structure and can realize an increase in speed of the arithmetic operation by decreasing the cut-off distance for a dense structure.

In the training of the model related to NNP, the model has become compatible with an ultra-dense structure and thereby can execute the training of a corresponding data set. As a result of this, it becomes also possible to form a model related to NNP stabilized in behavior by learning the ultra-dense structure.

Note that the above processing can be described as follows, or can be replaced entirely or partially as follows or combined with any configuration to the extent that there is no contradiction. In any description, replacement, or combination, the processing circuit 14 can set and/or determine an appropriate cut-off distance in the arithmetic processing of the interatomic potential.

(1) For example, when the distance between the atom i of interest and the candidate atom j exceeds the cut-off distance, the processing circuit 14 does not need to take the interaction between the atom i of interest and the candidate atom j into account at the timing when performing an arithmetic operation of the interatomic potential in the atomic structure. The processing circuit 14 can determine whether the cut-off distance is exceeded or not, using the screening factor. Further, the determination of the cut-off distance can be executed based on the density of the atoms present.

In the above processing, as another non-limiting example, the processing circuit 14 can determine not to take the interaction between the atom i of interest and the candidate atom j into account in the arithmetic operation of the interatomic potential, when the value of the screening factor calculated based on the distance between the atom i of interest and the candidate atom j exceeds a predetermined value. As a non-limiting example, the processing circuit 14 can also set the strength of the interaction based on the fact that the distance between the atom i of interest and the candidate atom j is a first predetermined value or less or is a second predetermined value or more and a third predetermined value or less (first predetermined value<second predetermined value<third predetermined value) or the like.

(2) The atomic structure is sometimes expressed by a graph, and the processing circuit 14 may set a value of the adjacency matrix or an amount corresponding to the adjacency matrix, for example, an amount in any form such as an adjacency list so as not to take the interaction between the atom i of interest and the candidate atom j into account about the atomic structure.

For example, the processing circuit 14, when taking into account an atomic structure for which the presence or absence of the interaction has been decided for all of sets of the atom i of interest and the candidate atom j, can form the atomic structure satisfying the definition of the graph at that timing. This does not need to be clearly defined as a graph and may be described in another arbitrary form.

Besides, an expressing method of the graph is not limited to a predetermined method. For example, the adjacency matrix is one of expression methods, and the graph does not need to be described in the form as the adjacency matrix as explained above but may be described in another form. For example, the graph may be the one describing atoms whose interaction needs to be taken into account from the atom of interest, in a list form. In this case, the atoms whose interaction needs to be taken into account are described in not an undirected list but a directed list, namely, an asymmetric matrix or list in which the atom i of interest takes the candidate atom j into account of the interaction but the candidate atom j does not take the atom i of interest into account of the interaction.

(3) The processing circuit 14 may execute the processing in the following order, or in the order arbitrarily changed to the extent that there is no contradiction as explained also in the above example.

(3-a) The processing circuit 14 executes an arithmetic operation related to the cut-off distance about an atomic pair included in the atomic structure. The processing circuit 14 can execute this arithmetic operation by calculating the screening factor about the atomic pair included in the atomic structure as a non-limiting example.

Note that the processing circuit 14 may execute the arithmetic operation related to the cut-off distance about all of atomic pairs included in the atomic structure, or may execute the arithmetic operation related to the cut-off distance about at least atomic pairs excluding some atomic pairs. The processing circuit 14 may extract only a predetermined number of candidate atoms, for example, in order closest in distance from the atom of interest, and execute the arithmetic operation related to the cut-off distances about atomic pairs of the predetermined number of atoms and the atom of interest (as an example, calculation of the screening factor). Further, an atom to be taken into account in the calculation of the screening factor may be decided based on a distance to an atom that is xth closest in distance from the atom i of interest or a distance from the atom i of interest to the candidate atom j.

(3-b) The processing circuit 14 determines whether atoms in each pair influence each other, namely, whether to take the interaction into account in the calculation of the interatomic potential, based on the arithmetic operation related to the cut-off distance at (3-a). The processing circuit 14 can execute this processing by determining the cut-off distance based on the screening factor as a non-limiting example.

(3-c) The processing circuit 14 generates a graph of the atomic structure based on a result of (3-b). Note that the processing circuit 14 may generate information including the result of (3-b) as a graph related to the atomic structure, namely, generate a graph including the connection between atoms as information on nodes based on a result of (2).

Further, the processing circuit 14 may generate a graph including not only an actual interatomic distance but also information related to the determination of the cut-off distance, for example, information related to the screening factor. In other words, as a non-limiting example, the processing circuit 14 may use the information related to the screening factor as input information on the atomic pair in the arithmetic operation of NNP.

(3-d) The processing circuit 14 calculates the interatomic potential using the information based on the atomic pair taking the cut-off distance in the atomic structure into account. For example, the processing circuit 14 inputs the graph including the above information into the model related to NNP and thereby can calculate the physical property values such as energy and force.

Further, the processing circuit 14 can also calculate the interatomic potential by creating a graph, and can also calculate the interatomic potential using information alternative to the graph including the atomic structure including the information related to the cut-off distance. For example, the processing circuit 14 can also execute the calculation of the interatomic potential by a method other than NNP, such as a classical method using the information related to the atomic structure including the information related to the cut-off distance.

(4) The processing circuit 14 may use not only the presence or absence of the interaction between atoms but also information on how much to take the effect of the interaction between atoms into account (strength of the interaction between atoms), as the interaction information to be used for the calculation of the interatomic potential. For example, when the screening factor exceeds the predetermined value, the processing circuit 14 does not take the interaction into account for the atomic pair, but when the screening factor is the predetermined value or less, the processing circuit 14 can also calculate the interatomic potential so as to continuously take the effect of the interaction into account. The processing circuit 14 includes, for example, the value related to the screening factor in the information such as a graph to smooth an energy curve surface and thereby can increase the speed of the arithmetic operation based on the cut-off distance and further improve the accuracy of the calculation.

The screening function for calculating the screening factor only needs to be a function describing that, for example, when atoms are present around certain atoms i and j, the interaction between these atoms i and j is weakened. By using the function, the processing circuit 14 can take the interaction into account so as to decrease the distance between the atoms in a pair whose interaction is taken into account when there are many surrounding atoms (in a dense state) and increase the distance between the atoms in a pair whose interaction is taken into account when there are few surrounding atoms (in a sparse state). In short, it becomes possible to adjust the cut-off distance between atoms based on the surrounding atoms.

In other words, the screening function only needs to be a function describing such a behavior that the cut-off distance of the atom decreases when there are many surrounding atoms.

The cut-off distance can be decided for each atomic pair included in the atomic structure. The processing circuit 14 can realize the determination related to the cut-off distance, for example, by calculating the screening factor for each atomic pair.

For example, when the atomic structure is input, the processing circuit 14 can execute the calculation of the interatomic potential by determining which atoms are connected, namely, between atoms in which atomic pair the interaction is to be taken into account, while taking the cut-off distance into account.

The processing circuit 14 can use the screening function expressed in eq. (1) and/or eq. (2) in the determination of the cut-off distance but, not limited to this, can use other functions for screening. For example, more simply, the processing circuit 14 can also select a method of simply extracting only a predetermined number of atoms in order of proximity to the atom of interest included in the atomic structure (an example of a function of returning a certain output for a certain input pair).

The processing mainly using NNP is performed in the above, but the determination related to the distance and density according to this embodiment can be used for methods other than that. For example, the determination can be used for an arbitrary simulation related to the atom in which the accuracy improves or the arithmetic operation speed improves when taking the cut-off into account. For example, the determination is applicable not to the arithmetic operation related to potential but to a classical method for predicting a dielectric constant or band gap or a method using a machine learning model.

As a matter of course, the determination is also applicable to the prediction of the physical property value using a neural network model, and also applicable to the prediction of the physical property value not using the neural network model. As an example not using the neural network model, the determination is also applicable to a classical method, for example, calculation related to classical potential.

(5) Explaining this embodiment from another aspect, it is possible to understand it as follows.

The processing circuit 14 can determine whether to take the interaction into account based on the information on positions of the atoms in the atomic structure (as an example, including the distance between atoms).

The positions of the atoms may be positions of two atomic pairs or may be positions of a plurality of such as three or more atoms.

Besides, the processing can be similarly performed also for the case of performing the arithmetic operation including a plurality of atomic structures as the atomic structure.

The aforementioned position may be information related to a relative position. The processing circuit 14 can also execute the processing, for example, using a vector indicating a relative position with respect to a certain atom.

As a matter of course, the position can include interatomic positional information related to three-dimensional coordinates.

Hereinafter, the interaction information can include the information related to the interaction, namely, the information on whether to take the interaction determined based on the cut-off distance into account.

A first atom may be an arbitrary one atom included in a plurality of atoms in the atomic structure. Using each of all or some of the plurality of atoms in the atomic structure as the first atom, the interaction information with respect to a second atom different from the first atom can be acquired.

The second atom may be any one atom included in the plurality of atoms in the atomic structure and an atom different from the first atom. Using each of all or some of the plurality of atoms in the atomic structure as the second atom, the interaction information with respect to the first atom can be acquired.

The interaction information may be information for setting the strength of the interaction between the first atom and the second atom in analysis processing of the plurality of atoms.

The interaction information may be a discrete value such as 0 or 1 or may be a continuous value. Here, one discrete value (for example, 0) may represent either that at least the interaction is not taken into account or that there is no interaction, in the analysis processing of the plurality of atoms. Besides, another discrete value for example, 1) may represent either that at least the interaction is taken into account or that there is interaction, in the analysis processing of the plurality of atoms. In short, the discrete value is an example of information related to the presence or absence of the interaction.

It is also possible to define the interaction information so that the value becomes smaller as the interaction is stronger. Further, the strength of the interaction should be flexibly determined from the viewpoint of calculation and, for example, the interaction information may be defined so that the value becomes larger as the interaction is stronger.

As explained above, the interaction information may be information calculated using the screening function.

The input information related to the function (including the model in NNP, or may be a linear function or may be a non-linear function) for acquiring the physical property value or the like may be the atomic structure generated based on the interaction information.

This atomic structure may be the one described by a graph or the one described in an arbitrary form other than the graph.

Further, the forms in this disclosure can be summarized as follows.

(6) In the case where the distance between the first atom and the second atom is the same, such a function that the screening factor becomes larger as the number of other atoms present in a space between the first atom and the second atom is larger may be used as the screening function.

Further, the screening factor may be calculated using at least one of the distance between atoms, the angle formed by a bond between atoms, and the relative position vector between atoms. For example, the screening factor may be calculated using a neural network architecture handling the atomic structure such as NNP or the like. As a concrete example, the screening factor may be output for each atomic bond using the atomic structure as an input using a graph neural network.

The acquisition of the interaction information using at least one of the number of atoms present in a predetermined space, the sparseness/denseness of atoms, the distance between atoms, the angle formed by a bond between atoms, and the relative position vector between atoms can be a non-limiting example of acquiring the interaction information based on the information related to the positions of the first atom, the second atom, and one or more other atoms.

The above embodiments can be summarized as follows, but not limited to them.

The trained models of above embodiments may be, for example, a concept that includes a model that has been trained as described and then distilled by a general method.

Some or all of each device (the information processing device) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

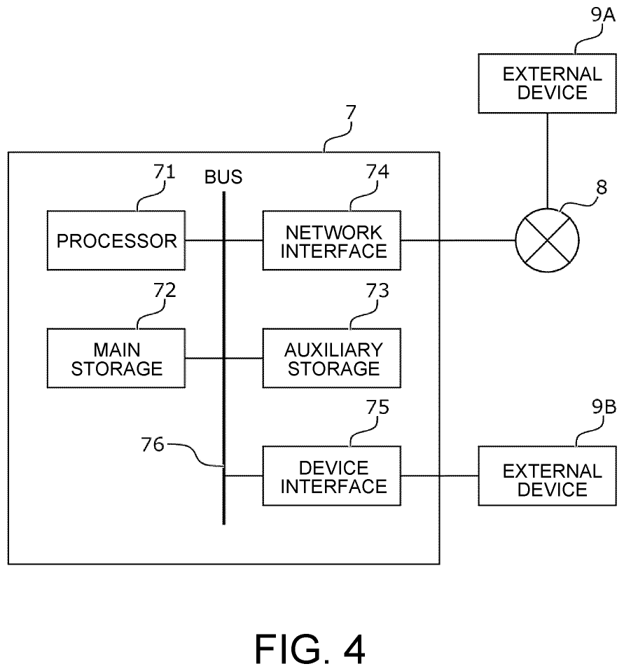

FIG. 4 is a block diagram illustrating an example of a hardware configuration of each device (the information processing device) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 4 is provided with each component one by one but may be provided with a plurality of the same components. Although one computer 7 is illustrated in FIG. 4, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (the information processing device) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (the information processing device) in the above embodiments may be executed in parallel processing using one or more processors or using a plurality of computers over a network. The various arithmetic operations may be allocated to a plurality of arithmetic cores in the processor and executed in parallel processing. Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuitry, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and/or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (the information processing device) in the above embodiments may be enabled by one or more processors 71. The processor 71 may refer to one or more electronic circuits located on one chip, or one or more electronic circuitries arranged on two or more chips or devices. In the case of a plurality of electronic circuitries is used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (the information processing device) in the above embodiments may be enabled by the main storage device 72 or the auxiliary storage device 73 or may be implemented by a built-in memory built into the processor 71. For example, the storages in the above embodiments may be implemented in the main storage device 72 or the auxiliary storage device 73.

In the case of each device (the information processing device) in the above embodiments is configured by at least one storage device (memory) and at least one processor connected/coupled to/with this at least one storage device, the at least processor may be connected to a single storage device. Or the at least storage may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8. Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B.

The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (the information processing device) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a-b, a-c, b-c, and a-b-c. It also covers combinations with multiple instances of any element such as, for example, a-a, a-b-b, or a-a-b-b-c-c. It further covers, for example, adding another element d beyond a, b, and/or c, such that a-b-c-d.

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,” “based on data,” “according to data,” “in accordance with data” (including similar expressions), unless otherwise specified, this may include cases where the result is obtained based only on the data, and may also include cases where the result is obtained by being affected factors, conditions, and/or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection/coupling,” “indirect connection/coupling,” “electrical connection/coupling,” “communicative connection/coupling,” “operative connection/coupling,” “physical connection/coupling,” or the like. The terms should be interpreted accordingly, depending on the context in which they are used, but any forms of connection/coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting/configuration of element A is configured/set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising/including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage/result), unless there are some other reasons, it should be understood that the effect is also obtained for one or more other embodiments having the configuration. However, it should be understood that the presence or absence of such an effect generally depends on various factors, conditions, and/or states, etc., and that such an effect is not always achieved by the configuration. The effect is merely achieved by the configuration in the embodiments when various factors, conditions, and/or states, etc., are met, but the effect is not always obtained in the claimed invention that defines the configuration or a similar configuration.

In the present specification (including the claims), when the term such as “maximize/maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize/minimization” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize/optimization” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data. Further, some storage devices among the plurality of storage devices may include a configuration for storing data.

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. An information processing device comprising:
one or more memories; and
one or more processors configured to:
acquire, based on information related to positions of a first atom, a second atom, and one or more other atoms, the first atom, the second atom, and the one or more other atoms being included in a plurality of atoms, interaction information between the first atom and the second atom;
generate, based on the interaction information, input information which is inputted into a model to be used for analysis of the plurality of atoms; and
acquire an analysis result of the plurality of atoms by inputting the input information into the model, wherein the interaction information includes information related to presence or absence of interaction.

2. The information processing device according to claim 1, wherein the information related to the presence or absence of the interaction includes information related to a cut-off distance between the first atom and the second atom.

3. The information processing device according to claim 1, wherein:
the interaction information includes information related to strength of the interaction between the first atom and the second atom.

4. The information processing device according to claim 1, wherein the one or more processors acquire the interaction information using a predetermined function.

5. The information processing device according to claim 4, wherein the predetermined function is a function based on:
a distance between the first atom and the second atom;
a respective distance or distances between the first atom and the one or more other atoms; and
a respective distance or distances between the second atom and the one or more other atoms.

6. The information processing device according to claim 1, wherein the information related to the positions includes at least:
a distance between the first atom and the second atom; and
a respective distance or distances between the first atom and the one or more other atoms.

7. The information processing device according to claim 6, wherein the information related to the positions further includes a respective distance or distances between the second atom and the one or more other atoms.

8. The information processing device according to claim 1, wherein the information related to the positions includes information related to the number of the one or more other atoms present in a space between the first atom and the second atom.

9. The information processing device according to claim 1, wherein the model is a neural network potential.

10. The information processing device according to claim 9, wherein the analysis result of the plurality of atoms includes at least information on energy or force.

11. An information processing method comprising:
acquiring, by one or more processors, based on information related to positions of a first atom, a second atom, and one or more other atoms, the first atom, the second atom, and the one or more other atoms being included in a plurality of atoms, interaction information between the first atom and the second atom;
generating, by the one or more processors, based on the interaction information, input information which is inputted into a model to be used for analysis of the plurality of atoms; and
acquiring, by the one or more processors, an analysis result of the plurality of atoms by inputting the input information into the model, wherein the interaction information includes information related to presence or absence of interaction.

12. The information processing method according to claim 11, wherein the information related to the presence or absence of the interaction includes information related to a cut-off distance between the first atom and the second atom.

13. The information processing method according to claim 11, wherein the interaction information includes information related to strength of the interaction between the first atom and the second atom.

14. The information processing method according to claim 11 further comprising acquiring, by the one or more processors, the interaction information using a predetermined function.

15. The information processing method according to claim 14, wherein the predetermined function is a function based on:
a distance between the first atom and the second atom;
a respective distance or distances between the first atom and the one or more other atoms; and
a respective distance or distances between the second atom and the one or more other atoms.

16. The information processing method according to claim 11, wherein the information related to the positions includes at least:
a distance between the first atom and the second atom; and
a respective distance or distances between the first atom and the one or more other atoms.

17. The information processing method according to claim 16, wherein the information related to the positions further includes a respective distance or distances between the second atom and the one or more other atoms.

18. The information processing method according to claim 11, wherein the information related to the positions includes information related to the number of the one or more other atoms present in a space between the first atom and the second atom.

19. The information processing method according to claim 11, wherein the model is a neural network potential.

20. A non-transitory computer readable medium storing a program causing one or more processors to execute an information processing method, the information processing method comprising:
acquiring, based on information related to positions of a first atom, a second atom, and one or more other atoms, the first atom, the second atom, and the one or more atoms being included in a plurality of atoms, interaction information between the first atom and the second atom;
generating, based on the interaction information, input information which is inputted into a model to be used for analysis of the plurality of atoms; and
acquiring an analysis result of the plurality of atoms by inputting the input information into the model, wherein the interaction information includes information related to presence or absence of interaction.
